(19) United States
(12) Patent Application Publication
(10) Pub. No.: US 2021/0109800 A1
(43) Pub. Date: Apr. 15, 2021

(54) METHOD AND APPARATUS FOR MONITORING DEVICE FAILURE

(71) Applicant: WANGSU SCIENCE & TECHNOLOGY CO., LTD., Shanghai (CN)

(72) Inventors: Tao CHEN, Shanghai (CN); Feng LIN, Shanghai (CN)

(21) Appl. No.: 16/463,488

(22) PCT Filed: Jun. 14, 2018
(86) PCT No.: PCT/CN2018/091208

§ 371 Date: May 23, 2019

(30) Foreign Application Priority Data
May 8, 2018 (CN) 201810433735.1

(51) Int. Cl. G06F 11/07

(52) U.S. Cl. CPC G06F 11/079; G06F 11/0775; G06F 11/0751

(57) ABSTRACT

The disclosure discloses a method and an apparatus for monitoring device failure, and belongs to the field of computer technology. The method includes: loading and executing a tool collection script that integrates a plurality of monitoring tools, periodically monitoring a plurality of preset key indicators through a plurality of preset basic tools included in the tool collection script; when a target preset key indicator is abnormal, collecting device operating parameters through a plurality of data collection tools that corresponds to the target preset key indicator and is included in the tool collection script; determining and feeding back a failure type to which the device operating parameters belong based on parameter characteristics corresponding to preset failure types. By adopting the disclosure, the time and effort spent by the user when monitoring device failure and the device processing resources consumed for performance monitoring may be saved.

### FIELD OF THE DISCLOSURE

The present disclosure relates to the field of computer technology and, more particularly, relates to a method and an apparatus for monitoring device failure.

### BACKGROUND

During the operation of a device, there are often operation failures due to hardware or software problems, which may reduce the processing ability of the device, cause execution logic errors, and even result in device shutdown, component damage, etc. In order to find out and solve the operation failures of the device as soon as possible, users can often check the performance indicators of the device through a performance monitoring program (which can be called a monitoring tool) to understand the operation status of the device.

Most of the existing monitoring tools are system programs that come with the device, e.g., “mpstat” for CPU, “iostat” for IO, “top” for processes, etc. Through these monitoring tools, the performance indicators of the device can be detected. Once the device fails, the corresponding performance indicators will be abnormal. As such, the user can view the performance indicators detected by the monitoring tools described above, and then though analyses based on the performance indicators and related operating parameters to obtain a general knowledge of the failure, and even accurately determine the cause, location, time, etc. of the failure. Further, the user can also specifically provide solutions for failure based on the above performance indicators.

In the process of implementing the present disclosure, the inventors have found that the existing technology has at least the following problems.

The types and the number of monitoring tools available for a target are very large, and the functional overlap between some monitoring tools is also high, such that for a certain operation failure of the device, the user often detects the same or different performance indicators through a large number of monitoring tools, which may not only waste a lot of time and effort of the user, but also consume a large amount of device processing resources for performance monitoring.

### BRIEF SUMMARY OF THE DISCLOSURE

In order to solve the problems in the existing technology, embodiments of the present disclosure provide a method and an apparatus for monitoring device failure. The technical solution is as follows.

In a first aspect, a method for monitoring a device failure is provided, and the method includes:
loading and executing a tool collection script that integrates a plurality of monitoring tools, periodically monitoring a plurality of preset key indicators through a plurality of preset basic tools included in the tool collection script;
when a target preset key indicator is abnormal, collecting device operating parameters through a plurality of data collection tools that corresponds to the target preset key indicator and is included in the tool collection script;
determining and feeding back the failure type to which the device operating parameters belong based on the parameter characteristics corresponding to preset failure types.

Optionally, the plurality of preset key indicators at least includes one or more of a CPU usage rate, a memory usage rate, a load value, an I/O waiting duration, and a CPU usage of each process.

Optionally, when the target preset key indicator is abnormal, collecting the device operating parameters through the plurality of data collection tools that corresponds to the target preset key indicator and is included in the tool collection script includes:
when at least one target preset key indicator is abnormal, for each of the at least one target preset key indicator, correspondingly configuring the data collection threads of the plurality of data collection tools included in the tool collection script;
removing duplicate data collection threads from all data collection threads;
configuring the daemon threads of all the data collection threads;
executing all the data collection threads to collect the device operating parameters.

Optionally, executing all the data collection threads to collect the device operating parameters includes:
according to the synchronization requirements of each of the data collection tools, dividing all the data collection threads into synchronous collection threads and asynchronous collection threads;
simultaneously executing all the synchronous collection threads in a multi-thread manner, and storing the collected device operating parameters into a multi-threaded storage queue with read-write locks;
after the execution of the synchronous collection threads ends, sequentially executing the asynchronous collection threads.

Optionally, determining and feeding back the failure type to which the device operating parameters belong based on the parameter characteristics corresponding to the preset failure types includes:
when the device operating parameters match with the states of the plurality of preset key indicators, determining and feeding back the failure type to which the device operating parameters belong based on the parameter characteristics corresponding to the preset failure types.

Optionally, determining and feeding back the failure type to which the device operating parameters belong based on the parameter characteristics corresponding to the preset failure types includes:
determining the parameter type and the corresponding parameter characteristics required for each failure type in a pre-stored failure type library in a one-by-one manner;
arranging the device operating parameters in the parameter type, and verifying whether the arranged device operating parameters are in consistent with the parameter characteristics;
when consistency is verified, confirming and feeding back the current failure type, otherwise verifying the next failure type.

Optionally, the method further includes:
receiving a configuration adjustment instruction inputted by the user for the tool collection script;
updating a script-execution configuration of the tool collection script according to the configuration adjustment instruction, the script-execution configuration at least including one or more of the following: the type of the monitoring tools and the operating parameters thereof, the preset key indicator and the corresponding preset basic tools and data collection tools, and the parameter characteristics and the feedback method corresponding to the failure type.

In a second aspect, an apparatus for monitoring device failure is provided, the apparatus including:
a monitoring module, configured to load and execute a tool collection script that integrates a plurality of monitoring tools, and periodically monitor a plurality of preset key indicators through a plurality of preset basic tools included in the tool collection script;
a collecting module, configured to, when a target preset key indicator is abnormal, collect device operating parameters through a plurality of data collection tools that corresponds to the target preset key indicator and is included in the tool collection script;
a determining module, configured to determine and feed back the failure type to which the device operating parameters belong based on the parameter characteristics corresponding to preset failure types.

Optionally, the plurality of preset key indicators at least includes one or more of a CPU usage rate, a memory usage rate, a load value, an I/O waiting duration, and a CPU usage of each process.

Optionally, the collecting module is used to:
when at least one target preset key indicator is abnormal, for each of the at least one target preset key indicator, correspondingly configure the data collection threads of the plurality of data collection tools included in the tool collection script;
remove duplicate data collection threads from all data collection threads;
configure the daemon threads of all the data collection threads;
execute all the data collection threads to collect the device operating parameters.

Optionally, the collecting module is used to:
according to the synchronization requirements of each of the data collection tools, divide all the data collection threads into synchronous collection threads and asynchronous collection threads;
simultaneously execute all the synchronous collection threads in a multi-thread manner, and store the collected device operating parameters into a multi-threaded storage queue with read-write locks;
after the execution of the synchronous collection threads ends, sequentially execute the asynchronous collection threads.

Optionally, the determining module is used to:
when the device operating parameters match with the states of the plurality of preset key indicators, determine and feed back the failure type to which the device operating parameters belong based on the parameter characteristics corresponding to the preset failure types.

Optionally, the determining module is used to:
determine the parameter type and the corresponding parameter characteristics required for each failure type in a pre-stored failure type library in a one-by-one manner;
arrange the device operating parameters in the parameter type, and verify whether the arranged device operating parameters are in consistent with the parameter characteristics;
when consistency is verified, confirm and feed back the current failure type, otherwise verify the next failure type.

Optionally, the apparatus further includes:
a receiving module, configured to receive a configuration adjustment instruction inputted by the user for the tool collection script;
an updating module, configured to update a script-execution configuration of the tool collection script according to the configuration adjustment instruction, the script-execution configuration at least including one or more of the following: the type of the monitoring tools and the operating parameters thereof, the preset key indicator and the corresponding preset basic tools and data collection tools, and the parameter characteristics and the feedback method corresponding to the failure type.

In a third aspect, a device is provided. The device includes a processor and a memory. The memory stores at least one instruction, at least one program segment, a set of code, or a set of instructions. The at least one instruction, the at least one program segment, the set of code, or the set of instructions is loaded and executed by the processor to implement the method for monitoring device failure as described in the first aspect.

In a fourth aspect, a computer readable storage medium is provided. The storage medium stores at least one instruction, at least one program segment, a set of code, or a set of instructions. The at least one instruction, the at least one program segment, and the code A method in which a set or set of instructions is loaded and executed by a processor to implement the method for monitoring device failure as described in the first aspect.

The beneficial effects brought by the technical solutions provided by the embodiments of the present disclosure include the following.

In the embodiments of the present disclosure, a tool collection script that integrates a plurality of monitoring tools is loaded and executed, and a plurality of preset key indicators are periodically monitored through a plurality of preset basic indicators included in the tool collection script; when a target preset key indicator is abnormal, device operating parameters are collected through a plurality of data collection tools that corresponds to the target preset key indicator and is included in the tool collection script; and the failure type to which the device operating parameters belong is determined and fed back based on the parameter characteristics corresponding to preset failure types. As such, through the monitoring tools in the tool collection script, the operation status of the device may be monitored in a unified and automatic manner. When the device fails, the failure type can be fed back more quickly and accurately based on the execution logic of the tool collection script, such that excessive participation of the user may not be necessary, and the consumed device processing resources may be low.

### BRIEF DESCRIPTION OF THE DRAWINGS

In order to more clearly illustrate the technical solutions of the embodiments of the present disclosure, the drawings used for illustrating the embodiments will be briefly described below. It should be understood that the following drawings merely illustrate some embodiments of the present disclosure. For those of ordinary skill in the art, other drawings can be obtained according to these drawings without any creative work.

FIG. 1 illustrates a flowchart of a method for monitoring device failure according to an embodiment of the present disclosure;

FIG. 2 illustrates a schematic flowchart of triggering data collection according to an embodiment of the present disclosure;

FIG. 3 illustrates a schematic flowchart of executing data collection according to an embodiment of the present disclosure;

FIG. 4 illustrates a schematic structural diagram of an apparatus for monitoring device failure according to an embodiment of the present disclosure;

FIG. 5 illustrates a schematic structural diagram of an apparatus for monitoring device failure according to an embodiment of the present disclosure;

FIG. 6 illustrates a schematic structural diagram of a device according to an embodiment of the present disclosure.

### DETAILED DESCRIPTION

In order to make the objects, technical solutions and advantages of the present disclosure clearer, the embodiments of the present disclosure will be further described in detail below with reference to the accompanying drawings.

The embodiments of the present disclosure provide a method for monitoring device failure. The executive entity of the method may be any device that has a program-execution function, and may be a server or a terminal. The device may include a processor, a memory, and a transceiver. The processor may be configured to perform the process for monitoring device failure in the following procedures. The memory may be configured to store data required and generated during processing, e.g., to store tool collection scripts, to record device operating parameters, etc. The transceiver may be configured to receive and send relevant data during processing, e.g., to receive instructions inputted by the user, to feed back monitoring results of device failures, etc. The device can support multiple processes to be executed simultaneously. When the process runs, it may occupy different processing resources of the device CPU, use a certain memory space, and generate disk I/O.

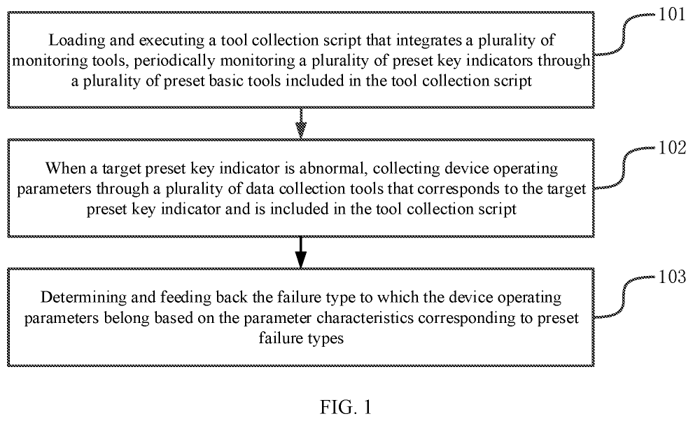

The processing flow shown in FIG. 1 will be described in detail below with reference to specific embodiments, and the content may include the following steps.

In step 101, a tool collection script that integrates a plurality of monitoring tools may be loaded and executed, a plurality of preset key indicators may be periodically monitored through a plurality of preset basic tools included in the tool collection script.

In one embodiment, a tool collection script that integrates a plurality of monitoring tools can be developed. The tool collection script may be able to monitor the operation status of the device from different angles using different monitoring tools, such that hardware or software failures generated during the operation of the device can be discovered in time. Specifically, after the tool collection script is installed on the device, the device can load and run the tool collection script, and periodically monitor a plurality of preset key indicators through a plurality of preset basic tools included in the tool collection script. Here, the plurality of preset key indicators may be preset. Through the plurality of preset key indicators, whether any failure occurs on the device may be determined in a relatively simple and timely manner, and for each preset key indicator, real-time monitoring can be implemented through a small number of preset basic tools capable of indicating whether the preset key indicator contains abnormal information. As such, a small number of basic tools may be operated to monitor the key indicators, the consumed device processing resources may be less, and the impact on the device performance may be relatively small.

Optionally, the plurality of preset key indicators described above may include one or more of a CPU usage rate, a memory usage rate, a load value, an I/O waiting duration, and a CPU usage of each process. It can be understood that, in other embodiments, the preset key indicators are not limited to the foregoing enumerated ones.

In one embodiment, five indicators of the CPU usage, the memory usage, the load value, the I/O wait time, and the CPU usage of each process may be selected as preset key indicators. In a corresponding manner, for the CPU usage, detection may be performed using a “mpstat” tool, the detection method may include performing detection once per cycle, and the detection duration may be 1 second; for the memory usage, the detection may be implemented by examining the fields of “used” and “free” in “free-m”, and the detection method may include performing detection once per cycle; for the load value, the detection may be implemented by examining the load field of the “/proc/load avg” file within 1 minute, and the detection method may include performing detection once per cycle; for the I/O waiting time, detection may be performed using the “mpstat” tool, the detection method may include performing detection once per cycle, and the detection duration may be 1 second; for the CPU usage of each process, detection may be performed a “top” tool, the detection method may include performing detection once per cycle, and the detection duration may be 1 second.

In step 102, when a target preset key indicator is abnormal, device operating parameters may be collected through a plurality of data collection tools that corresponds to the target preset key indicator and is included in the tool collection script.

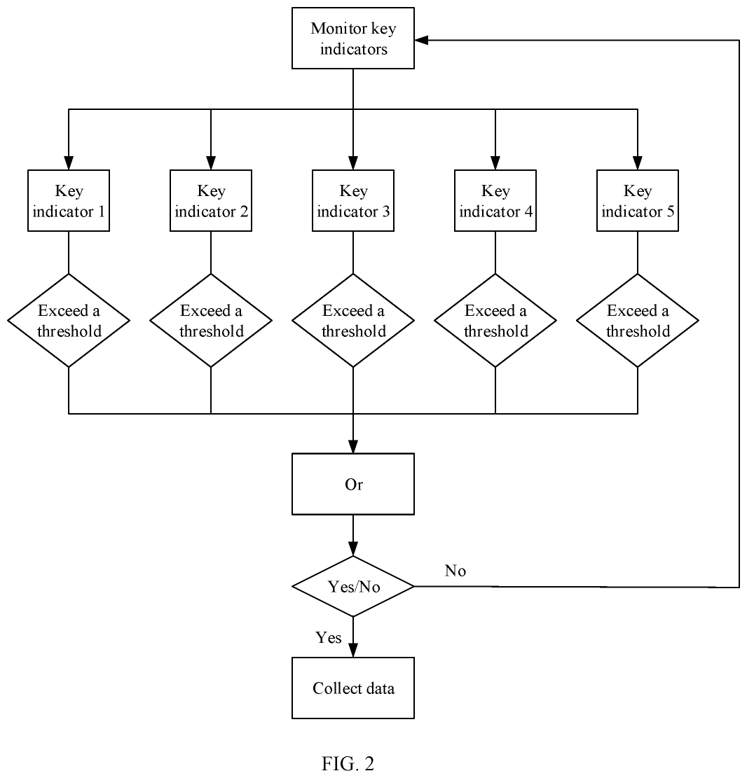

In one embodiment, when the device monitors the preset key indicators through the preset basic tools in the tool collection script, using a threshold determination method, the device may perform detection according to some empirical data used in daily analyses to determine whether the monitored preset key indicators are abnormal. Therefore, whether it is necessary to trigger a subsequent data collection process can be determined, and the specific processing is shown in FIG. 2. When a certain preset key indicator (such as a target preset key indicator) is found to be abnormal, the device may first determine a plurality of data collection tools that corresponds to the target preset key indicator and is included in the tool collection script, and may then collect device operating parameters through the plurality of the data collection tools. It should be understood that for different preset key indicators, data collection tools under the abnormal conditions may be preset, and the device operating parameters related to the abnormal preset key indicators may be collected based on the data collection tools. Here, on the one hand, the monitoring of the preset key indicators and the determination of the monitoring results may both take a short time, and when a preset key indicator is abnormal, the time from the discovery of the abnormality to the collection of the operating parameters of the device may be relatively short, and the possibility for the abnormal problem to disappear or change may be low; on the other hand, when the preset key indicators are normal, no processing may be performed, and a large amount of invalid data collection processing may be avoided.

Optionally, the device operating parameters may be collected by configuring the data collection threads. Correspondingly, the processing of step 102 may be as follows: when at least one target preset key indicator is abnormal, for each target preset key indicator, the data collection threads of the plurality of data collection tools included in the tool collection scrip may be configured correspondingly; the duplicate data collection threads in all data collection threads may be eliminated; the daemon threads of all data collection threads may be configured; and all data collection threads may be performed to collect the device operating parameters.

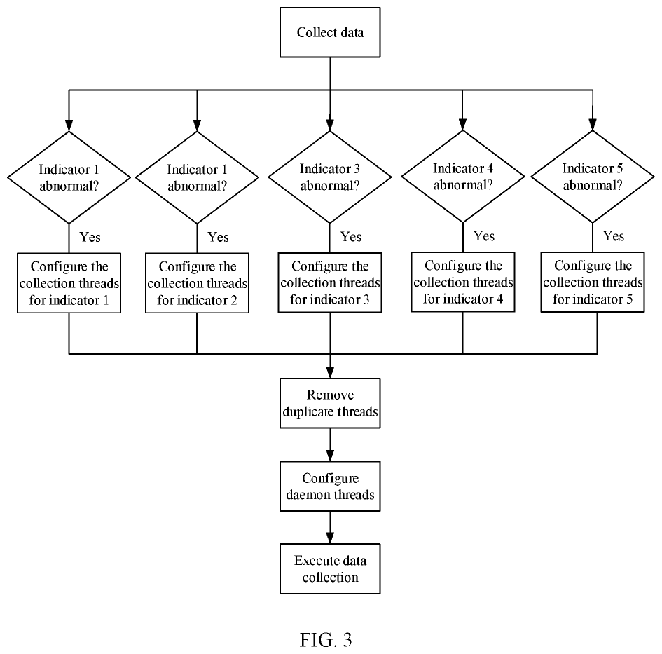

In one embodiment, when detecting that at least one target preset key indicator is abnormal, for each target preset key indicator, the device may first determine a plurality of data collection tools that corresponds to the target preset key indicator and is included in the tool collection script, and then configure the data collection threads corresponding to the data collection tools. Further, the device may be able to remove the duplicate data collection threads from all configured data collection threads. Further, the device can also configure the daemon threads for all data collection threads to ensure that only when all the data collection threads are executed, and all the required device operating parameters are collected, a subsequent process may then be performed. In turn, the device may be able to execute all the data collection threads to collect device operating parameters. The above implementation process can refer to FIG. 3.

Optionally, in order to alleviate the pressure on the CPU and the memory of the device during the data collection process, and ensure the consistency of the collected operating parameters of the device, the data collection threads may be divided into synchronous collection threads and asynchronous collection threads. The corresponding processing may be as follows: according to the synchronization requirements of each data collection tool, all the data collection threads may be divided into synchronous collection threads and asynchronous collection threads; all the synchronous collection threads may be simultaneously executed in a multi-thread manner, and the collected device operating parameters may be stored into a multi-threaded storage queue with read-write locks; after the execution of the synchronous collection threads ends, the asynchronous collection threads may be sequentially executed.

In one embodiment, different data collection tools may have different synchronization requirements for startup time. For example, tools such as “mpstat”, “top”, etc. may have relatively high synchronization requirements, while tools such as “load”, etc. may have relatively low synchronization requirements. Therefore, in the process of executing all the data collection threads to collect the device operating parameters, the device may first divide all the data collection threads into synchronous collection threads and asynchronous collection threads according to the synchronization requirements of each data collection tool, and then simultaneously execute all the synchronous collection threads in a multi-thread manner, and use a multi-threaded storage queue with read-write locks to store the data collection results. As such, confusion in the collected device operating parameters may be avoided. After the execution of the synchronous collection threads ends, the device may sequentially execute the asynchronous collections threads.

In step 103, based on the parameter characteristics corresponding to preset failure types, the failure type to which the device operating parameters belong may be determined and fed back.

In one embodiment, those skilled in the art can predict various failures that may occur in the device, and record the parameter characteristics of the device operating parameters when each failure occurs in the device, and then the parameter characteristics and the corresponding failure type can be written into the source code of the tool collection script. After loading and executing the tool collection script, the device can read the data content of the above parameter characteristics and failure type. As such, after the device operating parameters are collected, the device can determine the failure type to which the device operating parameters belong based on the parameter characteristics corresponding to the preset failure types. In addition, the device may feed back the failure type to the user of the device. Specifically, the feedback method may include directly displaying the failure type on the screen of the device, or writing the failure type into the operation log of the device, or sending the failure type to the user's default mailbox by email.

Optionally, before determining the failure type to which the device operating parameters belong, the device operating parameters may be validated first, and correspondingly, the processing of step 103 may be as follows: when the device operating parameters match with the states of the plurality of preset key indicators, based on the parameter characteristics corresponding to the preset failure types, the failure type to which the device operating parameters belong may be determined and fed back.

In one embodiment, after the device operating parameters are collected, the device may re-verify whether the device operating parameters are consistent with the states of the plurality of preset key indicators detected in step 102, that is, based on the device operating parameters, determine whether the target preset key indicators are abnormal, and whether the preset key indicators other than the target preset key indicators are normal. When the states do not match, the device operating parameters of the current collection may be discarded, and the next trigger of step 102 is awaited. When the states are consistent, the failure type to which the device operating parameters belong may be determined and fed back based on the parameter characteristics corresponding to the preset failure type.

Optionally, when determining the failure type of the device, the device operating parameters may be compared with all failure types in a one by one manner. Correspondingly, the processing of step 103 may be as follows: the parameter type and the corresponding parameter characteristics required for each failure type in a pre-stored failure type library may be determined in a one by one manner; the device operating parameters in the parameter type may be arranged, and whether the arranged device operating parameters are in consistent with the parameter characteristics may be verified; when consistency is verified, the current failure type may be confirmed and fed back, otherwise the next failure type may be verified.

In one embodiment, after loading the tool collection script, the device can maintain a failure type library, and the failure type library can summarize all the possible device failures and the parameter characteristics of the device operating parameters when the failures take place. Furthermore, after the device operating parameters are collected, the parameter type and corresponding parameter characteristics required for each failure type in the failure type library may be determined in a one by one manner, and then the collected device operating parameters may be arranged, and the device operating parameters in the corresponding parameter type may be summarized. After that, whether the arranged device operating parameters are in consistent with the parameter characteristics corresponding to the current failure type can be verified. When consistency is verified, the current failure type can be confirmed and fed back. Otherwise, the next failure type may be verified, that is, the processes of determining the parameter type and the parameter characteristics, arranging the device operating parameters, and verifying whether the parameter characteristics are met may be re-executed.

Optionally, for the specific configuration of the tool collection script involved in the foregoing process, the user may make any setting according to the actual needs, and the corresponding processing may be as follows: a configuration adjustment instruction inputted by the user for the tool collection script may be received; a script-execution configuration of the tool collection script may be updated according to the configuration adjustment instruction.

In the process, the script-execution configuration may at least include one or more of the following: the type of the monitoring tools and the operating parameters thereof, the preset key indicator and the corresponding preset basic tools and data collection tools, and the parameter characteristics and the feedback method corresponding to the failure type.

In one embodiment, when the device loads and executes the tool collection script, the tool collection script may be executed by default based on the default values in the tool collection script. The default values may be preset by the developer of the tool collection script, and may be suitable for most scenarios where device failures are monitored. The user may be able to adjust the configuration item to change the script-execution configuration, such as the type of the monitoring tools in the tool collection script and the operating parameters, the preset key indicator and the corresponding preset basic tools and data collection tools, the parameter characteristics and the feedback method corresponding to the failure type, etc. Specifically, after the user performs the corresponding configuration adjustment operation, the device may be able to receive the configuration adjustment instruction inputted by the user for the tool collection script, and then update the script-execution configuration of the tool collection script according to the configuration adjustment instruction.

In the embodiments of the present disclosure, a tool collection script that integrates a plurality of monitoring tools may be loaded and executed, and a plurality of preset key indicators may be periodically monitored through a plurality of preset basic indicators included in the tool collection script; when a target preset key indicator is abnormal, the device operating parameters may be collected through a plurality of data collection tools that corresponds to the target preset key indicator and is included in the tool collection script; and the failure type to which the device operation parameters belong is determined and fed back based on the parameter characteristics corresponding to the preset failure types. As such, through the monitoring tools in the tool collection script, the operation status of the device may be monitored in a unified and automatic manner. When the device fails, the failure type can be fed back more quickly and accurately based on the execution logic of the tool collection script, such that excessive participation of the user may not be necessary, and the consumed device processing resources may be low.

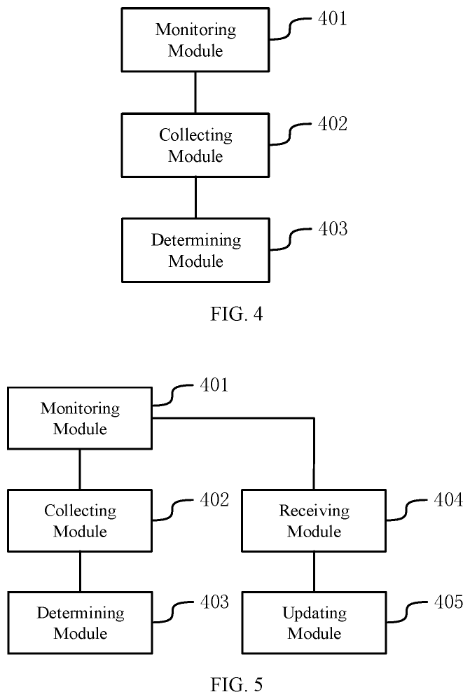

Based on the same technical concept, the embodiments of the present disclosure also provide an apparatus for monitoring device failure. As shown in FIG. 4, the apparatus may include:
a monitoring module 401, configured to load and execute a tool collection script that integrates a plurality of monitoring tools, and periodically monitor a plurality of preset key indicators through a plurality of preset basic tools included in the tool collection script;
a collecting module 402, configured to, when a target preset key indicator is abnormal, collect device operating parameters using a plurality of data collection tools corresponding to the target preset key indicator and included in the tool collection script;
a determining module 403, configured to determine and feed back the failure type to which the device operating parameters belong based on the parameter characteristics corresponding to preset failure types.

Optionally, the plurality of preset key indicators at least includes one or more of a CPU usage rate, a memory usage rate, a load value, an I/O waiting duration, and a CPU usage of each process.

Optionally, the collecting module 402 may be used to:
when at least one target preset key indicator is abnormal, for each of the at least one target preset key indicator, correspondingly configure the data collection threads of the plurality of data collection tools included in the tool collection script;
remove duplicate data collection threads from all data collection threads;
configure the daemon threads of all the data collection threads;
execute all the data collection threads to collect the device operating parameters.

Optionally, the collecting module 402 may be used to:
according to the synchronization requirements of each of the data collection tools, divide all the data collection threads into synchronous collection threads and asynchronous collection threads;
simultaneously execute all the synchronous collection threads in a multi-thread manner, and store the collected device operating parameters into a multi-threaded storage queue with read-write locks;
after the execution of the synchronous collection threads ends, sequentially execute the asynchronous collection threads.

Optionally, the determining module 403 may be specifically used to:
when the device operating parameters match with the states of the plurality of preset key indicators, determine and feed back the failure type to which the device operating parameters belong based on the parameter characteristics corresponding to the preset failure types.

Optionally, the determining module 403 may be specifically used to:
determine the parameter type and the corresponding parameter characteristics required for each failure type in a pre-stored failure type library in a one-by-one manner;
arrange the device operating parameters in the parameter type, and verify whether the arranged device operating parameters are in consistent with the parameter characteristics;
when consistency is verified, confirm and feed back the current failure type, otherwise verify the next failure type.

Optionally, as shown in FIG. 5, the apparatus may also include:
a receiving module 404, configured to receive a configuration adjustment instruction inputted by the user for the tool collection script;
an updating module 405, configured to update a script-execution configuration of the tool collection script according to the configuration adjustment instruction, the script-execution configuration at least including one or more of the following: the type of the monitoring tools and the operating parameters thereof, the preset key indicator and the corresponding preset basic tools and data collection tools, and the parameter characteristics and the feedback method corresponding to the failure type

In the embodiments of the present disclosure, a tool collection script that integrates a plurality of monitoring tools may be loaded and executed, and a plurality of preset key indicators may be periodically monitored through a plurality of preset basic indicators included in the tool collection script; when a target preset key indicator is abnormal, the device operating parameters may be collected through a plurality of data collection tools that corresponds to the target preset key indicator and is included in the tool collection script; and the failure type to which the device operation parameters belong is determined and fed back based on the parameter characteristics corresponding to the preset failure types. As such, through the monitoring tools in the tool collection script, the operation status of the device may be monitored in a unified and automatic manner. When the device fails, the failure type can be fed back more quickly and accurately based on the execution logic of the tool collection script, such that excessive participation of the user may not be necessary, and the consumed device processing resources may be low.

It should be noted that, when monitoring failures of a device, the apparatus for monitoring device failure provided by the embodiments above is merely illustrated based on the division of the functional modules described above. In actual applications, the functions may be allocated to different functional modules for implementation according to the needs. That is, the internal structure of the apparatus may be divided into different functional modules to implement all or part of the functions described above. In addition, the apparatus for monitoring device failure provided by the embodiments above is conceptually the same as the method for monitoring device failure, and the specific implementation process can be referred to the embodiments of the method, and the details are not described herein again.

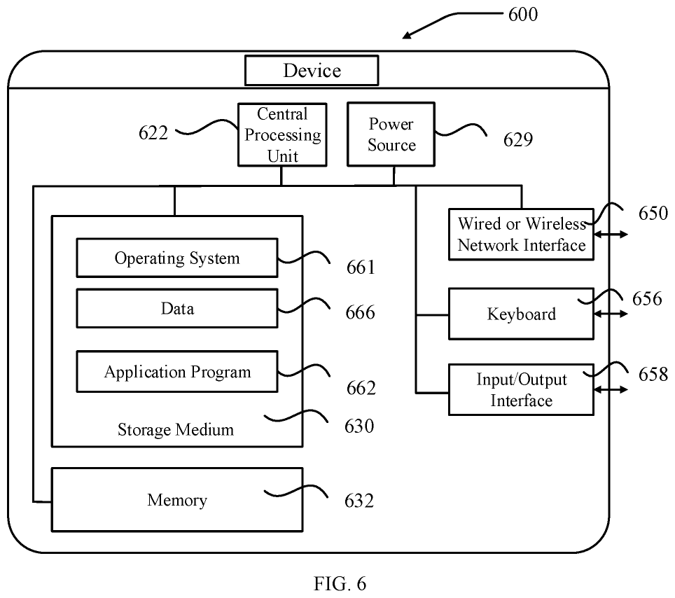

FIG. 6 illustrates a schematic structural diagram of a device according to an embodiment of the present disclosure. The device 600 may vary considerably depending on configuration or performance, and may include one or more central processing units 622 (e.g., one or more processors) and a memory 632, one or more storage media 630 for storing application programs 662 or data 666 (for example, one or one massive storage devices). Among them, the memory 632 and the storage media 630 may be short-term storages or persistent storages. The programs stored on the storage media 630 may include one or more modules (not shown), and each module may include a series of instruction operations of the device. Furthermore, the central processing unit 622 may be configured to communicate with the storage media 630, and on the device 600, execute the series of instruction operations in the storage media 630.

The device 600 may also include one or more power sources 626, one or more wired or wireless network interfaces 650, one or more input/output interfaces 658, one or more keyboards 656, and/or one or more operating systems 661, such as Windows Server™, Mac OS X™, Unix™, Linux™, FreeBSD™, etc.

The device 600 may include a memory, and one or more programs. The one or more programs may be stored in the memory, and may be configured to be executed by one or more processors. The one or more programs may include instructions described above for monitoring device failure.

Those skilled in the art shall understand that the implementation of all or part of the steps of the above embodiments may be completed by hardware, or may be completed by using a program to instruct related hardware. The program may be stored in a computer readable storage medium. The storage medium mentioned above may be a read only memory, a magnetic disk or optical disk, etc.

The above are only the preferred embodiments of the present disclosure, and are not intended to limit the present disclosure. Any modifications, equivalents, improvements, etc., that are within the spirit and scope of the present disclosure, shall be included in the scope of protection of the present disclosure.

1. A method for monitoring device failure, the method comprising:
loading and executing a tool collection script that integrates a plurality of monitoring tools, periodically monitoring a plurality of preset key indicators through a plurality of preset basic tools included in the tool collection script;
when a target preset key indicator is abnormal, collecting device operating parameters through a plurality of data collection tools that corresponds to the target preset key indicator and is included in the tool collection script; and
determining and feeding back a failure type to which the device operating parameters belong based on parameter characteristics corresponding to preset failure types.

2. The method according to claim 1, wherein:
the plurality of preset key indicators at least includes one or more of a CPU usage rate, a memory usage rate, a load value, an I/O waiting duration, and a CPU usage of each process.

3. The method according to claim 1, wherein when the target preset key indicator is abnormal, collecting the device operating parameters through the plurality of data collection tools that corresponds to the target preset key indicator and is included in the tool collection script includes:
when at least one target preset key indicator is abnormal, for each of the at least one target preset key indicator, configuring data collection threads of the plurality of data collection tools that corresponds to the target preset key indicator and is included in the tool collection script;
removing duplicate data collection threads from all data collection threads;
configuring daemon threads of all the data collection threads; and
executing all the data collection threads to collect the device operating parameters.

4. The method according to claim 3, wherein executing all the data collection threads to collect the device operating parameters includes:
according to synchronization requirements of each of the data collection tools, dividing all the data collection threads into synchronous collection threads and asynchronous collection threads;
simultaneously executing all the synchronous collection threads in a multi-thread manner, and storing the collected device operating parameters into a multi-threaded storage queue with read-write locks; and
after execution of the synchronous collection threads ends, sequentially executing the asynchronous collection threads.

5. The method according to claim 1, wherein determining and feeding back the failure type to which the device operating parameters belong based on the parameter characteristics corresponding to the preset failure types includes:
when the device operating parameters match with states of the plurality of preset key indicators, determining and feeding back the failure type to which the device operating parameters belong based on the parameter characteristics corresponding to the preset failure types.

6. The method according to claim 1, wherein determining and feeding back the failure type to which the device operating parameters belong based on the parameter characteristics corresponding to the preset failure types includes:
determining a parameter type and corresponding parameter characteristics required for each failure type in a pre-stored failure type library in a one-by-one manner;
arranging the device operating parameters in the parameter type, and verifying whether the arranged device operating parameters are in consistent with the parameter characteristics; and
when consistency is verified, confirming and feeding back a current failure type, otherwise verifying a next failure type.

7. The method according to claim 1, further including:
receiving a configuration adjustment instruction inputted by a user for the tool collection script; and
updating a script-execution configuration of the tool collection script according to the configuration adjustment instruction, wherein the script-execution configuration at least includes one or more of following: a type of monitoring tools and operating parameters thereof, a preset key indicator and corresponding preset basic tools and data collection tools, and parameter characteristics and a feedback method corresponding to the failure type.

8. An apparatus for monitoring device failure, comprising:
a monitoring module, configured to load and execute a tool collection script that integrates a plurality of monitoring tools, and periodically monitor a plurality of preset key indicators through a plurality of preset basic tools included in the tool collection script;
a collecting module, configured to, when a target preset key indicator is abnormal, collect device operating parameters through a plurality of data collection tools that corresponds to the target preset key indicator and is included in the tool collection script; and
a determining module, configured to determine and feed back a failure type to which the device operating parameters belong based on parameter characteristics corresponding to preset failure types.

9. The apparatus according to claim 8, wherein:
the plurality of preset key indicators at least includes one or more of a CPU usage rate, a memory usage rate, a load value, an I/O waiting duration, and a CPU usage of each process.

10. The apparatus according to claim 8, wherein the collecting module is used to:
when at least one target preset key indicator is abnormal, for each of the at least one target preset key indicator, configure the data collection threads of the plurality of data collection tools that corresponds to the target preset key indicator and is included in the tool collection script;
remove duplicate data collection threads from all data collection threads;
configure daemon threads of all the data collection threads; and
execute all the data collection threads to collect the device operating parameters.

11. The apparatus according to claim 10, wherein the collecting module is used to:
according to synchronization requirements of each of the data collection tools, divide all the data collection threads into synchronous collection threads and asynchronous collection threads;
simultaneously execute all the synchronous collection threads in a multi-thread manner, and store the collected device operating parameters into a multi-threaded storage queue with read-write locks; and
after execution of the synchronous collection threads ends, sequentially execute the asynchronous collection threads.

12. The apparatus according to claim 8, wherein the determining module is used to:
when the device operating parameters match with states of the plurality of preset key indicators, determine and feed back the failure type to which the device operating parameters belong based on the parameter characteristics corresponding to the preset failure types.

13. The apparatus according to claim 8, wherein the determining module is used to:
determine a parameter type and corresponding parameter characteristics required for each failure type in a pre-stored failure type library in a one-by-one manner;
arrange the device operating parameters in the parameter type, and verify whether the arranged device operating parameters are in consistent with the parameter characteristics; and
when consistency is verified, confirm and feed back a current failure type, otherwise verify a next failure type.

14. The apparatus according to claim 8, further including:
a receiving module, configured to receive a configuration adjustment instruction inputted by a user for the tool collection script; and
an updating module, configured to update a script-execution configuration of the tool collection script according to the configuration adjustment instruction, wherein the script-execution configuration includes at least one or more of a type of monitoring tools and operating parameters thereof, a preset key indicator and corresponding preset basic tools and data collection tools, and parameter characteristics and a feedback method corresponding to the failure type.

15. A device, comprising a processor and a memory, the memory storing at least one instruction, at least one program segment, a set of code, or a set of instructions, wherein the at least one instruction, the at least one program segment, the set of code, or the set of instructions is loaded and executed by the processor to implement the method for monitoring device failure according to claim 1.

16. A computer readable storage medium, storing at least one instruction, at least one program segment, a set of code, or a set of instructions, wherein the at least one instruction, the at least one program segment, the set of code, or the set of instructions is loaded and executed by a processor to implement the method for monitoring device failure according to claim 1.
